(19) United States
(12) Patent Application Publication
(10) Pub. No.: US 2015/0221064 A1
(43) Pub. Date: Aug. 6, 2015

(54) USER DISTANCE BASED MODIFICATION OF A RESOLUTION OF A DISPLAY UNIT INTERFACED WITH A DATA PROCESSING DEVICE AND/OR A DISPLAY AREA SIZE THEREON

(71) Applicant: NVIDIA Corporation, Santa Clara, CA (US)

(72) Inventors: Jithin Thomas, Pune (IN); Darshan Uppinkere, Pune (IN)

(21) Appl. No.: 14/171,768

(22) Filed: Feb. 3, 2014

(51) Int. Cl. G06T 3/40; G06F 3/0481; G06F 3/01

(52) U.S. Cl. CPC G06T 3/40; G06F 3/011; G06F 3/0481; G06F 2203/011; G06F 2203/04806

(57) ABSTRACT

A method includes obtaining, through a distance sensor in conjunction with a processor of a data processing device communicatively coupled to a memory, data related to a distance between a user of the data processing device and a display unit associated therewith. The method also includes automatically modifying, through the processor, a resolution of the display unit and/or a size of an area in which data is to be rendered on the display unit in accordance with the obtained data.

### FIELD OF TECHNOLOGY

This disclosure relates generally to data processing devices and, more particularly, to user distance based modification of a resolution of a display unit interfaced with a data processing device and/or a display area size thereon.

### BACKGROUND

A data processing device (e.g., a desktop computer, a laptop computer, a notebook computer, a smart television, a smart display, a netbook, a mobile device such as a mobile phone or a tablet) may include a processor configured to render data on a display unit (e.g., Liquid Crystal Display (LCD), Light Emitting Diode (LED) display) associated therewith. A user of the data processing device may physically move away from the display unit in order to view a screen thereof comfortably and/or with less eye strain. However, the data rendered on the display unit may be less readable when the user is farther away therefrom.

### SUMMARY

Disclosed are a method, a device and/or a system of user distance based modification of a resolution of a display unit interfaced with a data processing device and/or a display area size thereon.

In one aspect, a method includes obtaining, through a distance sensor in conjunction with a processor of a data processing device communicatively coupled to a memory, data related to a distance between a user of the data processing device and a display unit associated therewith. The method also includes automatically modifying, through the processor, a resolution of the display unit and/or a size of an area in which data is to be rendered on the display unit in accordance with the obtained data.

In another aspect, a non-transitory medium, readable through a data processing device and including instructions embodied therein that are executable through the data processing device, is disclosed. The non-transitory medium includes instructions to obtain, through a distance sensor in conjunction with a processor of the data processing device communicatively coupled to a memory, data related to a distance between a user of the data processing device and a display unit associated therewith. The non-transitory medium also includes instructions to automatically modify, through the processor, a resolution of the display unit and/or a size of an area in which data is to be rendered on the display unit in accordance with the obtained data.

In yet another aspect, a data processing device includes a memory, a processor communicatively coupled to the memory, and a distance sensor interfaced with the processor. The distance sensor is configured to obtain data related to a distance between a user of the data processing device and a display unit associated therewith in conjunction with the processor. In accordance with the obtained data related to the distance, the processor is configured to execute instructions to automatically modify a resolution of the display unit and/or a size of an area in which data is to be rendered on the display unit.

The methods and systems disclosed herein may be implemented in any means for achieving various aspects, and may be executed in a form of a non-transitory machine-readable medium embodying a set of instructions that, when executed by a machine, cause the machine to perform any of the operations disclosed herein.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a data processing device, according to one or more embodiments.

FIG. 2 is a schematic view of an example distance sensor utilizable in the data processing device of FIG. 1.

FIG. 3 is a schematic view of another example distance sensor utilizable in the data processing device of FIG. 1.

FIG. 4 is a schematic view of interaction between a driver component and a processor of the data processing device of FIG. 1, according to one or more embodiments.

FIG. 5 is a schematic view of display data on a screen of a display unit of the data processing device of FIG. 1 upon modification of a resolution thereof based on a distance between a user of the data processing device and the display unit.

FIG. 6 is a schematic view of display modes associated with the display unit of the data processing device of FIG. 1 being stored in a memory thereof.

FIG. 7 is a schematic view of modification of a size of a display area on a screen of the display unit of the data processing device of FIG. 1 based on the distance between the user of the data processing device and the display unit.

FIG. 8 is a process flow diagram detailing operations involved in user distance based modification of a resolution of the display unit of the data processing device of FIG. 1 and/or a display area size thereon, according to one or more embodiments.

Other features of the present embodiments will be apparent from the accompanying drawings and from the detailed description that follows.

### DETAILED DESCRIPTION

Example embodiments, as described below, may be used to provide a method, a device and/or a system of user distance based modification of a resolution of a display unit interfaced with a data processing device and/or a display area size thereon. Although the present embodiments have been described with reference to specific example embodiments, it will be evident that various modifications and changes may be made to these embodiments without departing from the broader spirit and scope of the various embodiments.

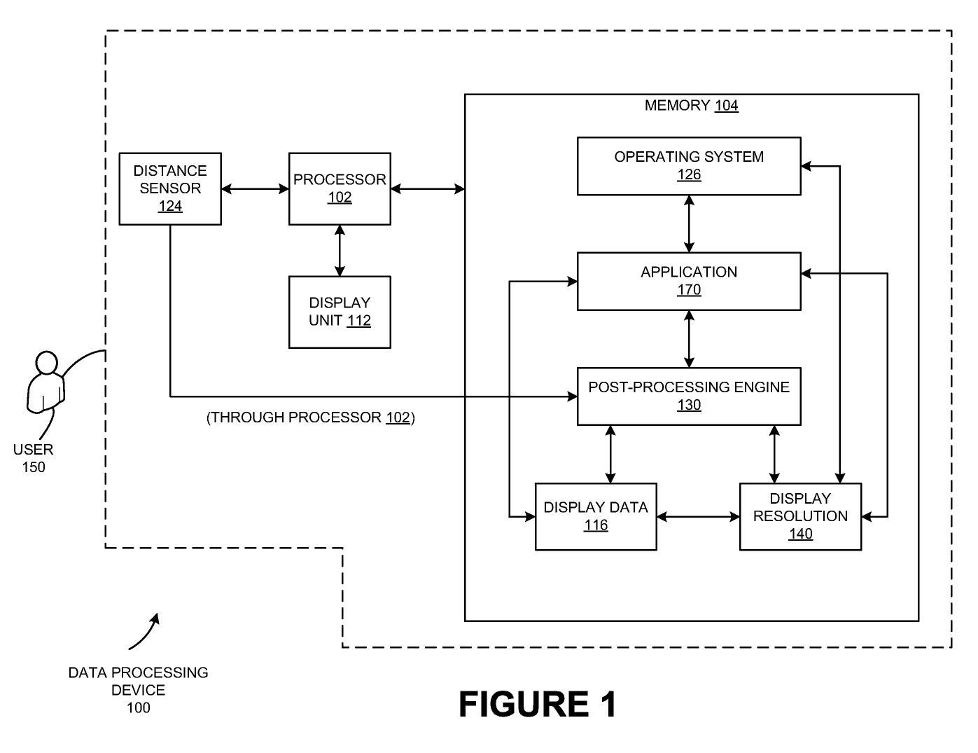

FIG. 1 shows a data processing device 100, according to one or more embodiments. In one or more embodiments, data processing device 100 may be a laptop computer, a desktop computer, a smart television, a smart display, a notebook computer, a netbook or a mobile device such as a mobile phone and a tablet. Other forms of data processing device 100 are within the scope of the exemplary embodiments discussed herein. In one or more embodiments, data processing device 100 may include a processor 102 (e.g., a Central Processing Unit (CPU), a Graphics Processing Unit (GPU) and/or another processor such as a microcontroller) communicatively coupled to a memory 104 (e.g., a volatile memory and/or a non-volatile memory); memory 104 may include storage locations configured to be addressable through processor 102.

In one or more embodiments, memory 104 of data processing device 100 may include display data 116 configured to be rendered on a display unit 112 associated with data processing device 100; for example, processor 102 may perform appropriate processing (e.g., data conversion) on display data 116 prior to rendering thereof on display unit 112; FIG. 1 shows display unit 112 as being interfaced with processor 102. In one or more embodiments, a post-processing engine 130 (e.g., a set of instructions) may execute on processor 102; post-processing engine 130 may be configured to receive display data 116 and an output of a distance sensor 124 (to be discussed below; distance sensor 124 is shown interfaced with processor 102) and perform appropriate processing on display data 116 prior to rendering thereof on display unit 112; the aforementioned processing may enhance readability of a screen content of display unit 112 and/or reduce power consumption through data processing device 100, as will be discussed below.

FIG. 1 also shows display resolution 140 being stored in memory 104. Display resolution 140 may be understood as a number of pixels of display data 116 to be displayed on display unit 112 along each dimension (e.g., length, width perpendicular to the length) thereof. In one or more embodiments, with regard to input display data 116 of a format incompatible with display unit 112, processor 102 may be configured to scale display data 116 to match said input display data 116 to display unit 112. It should be noted that display resolution 140 may be part of configuration data (not shown) related to other settings associated with display unit 112.

Also, display resolution 140 may be understood as the number of pixels of display data 116 per unit distance or area (e.g., pixels per inch (PPI) of a dimension of display unit 112). Other reasonable and implementation-wise feasible interpretations of display resolution 140 are within the scope of the exemplary embodiments discussed herein.

In one or more embodiments, data processing device 100 may execute an application 170 thereon to configure display unit 112. An example application 170 may be NVIDIA® Control Panel. In one or more embodiments, application 170 may provide a user interface for the aforementioned configuration. A user 150 of data processing device 100 may be provided with a capability to select display resolution 140 from multiple options provided through the user interface. Alternately, user 150 may input a desired display resolution 140 through the user interface; display data 116 may be fit into said display resolution 140 prior to rendering thereof on display unit 112.

In one or more embodiments, as mentioned above, data processing device 100 may include a distance sensor 124 associated therewith to track a distance between user 150 and display unit 112/data processing device 100. In one or more embodiments, user 150 may be provided a capability to trigger the process of distance sensing; the triggering may be possible through a physical button associated with data processing device 100 or display unit 112, through the user interface provided by application 170 and/or loading of an operating system 126 to be executed on data processing device 100. FIG. 1 shows operating system 126 as being stored in memory 104.

In the case of loading of operating system 126, the triggering may be an automatic process going on in the background or foreground. Other forms of triggering are within the scope of the exemplary embodiments discussed herein. The triggering of the process may cause a distance between user 150 and display unit 112/data processing device 100 to be sensed through distance sensor 124. In one or more embodiments, the sensing may occur periodically; alternately, the sensing may be continuous.

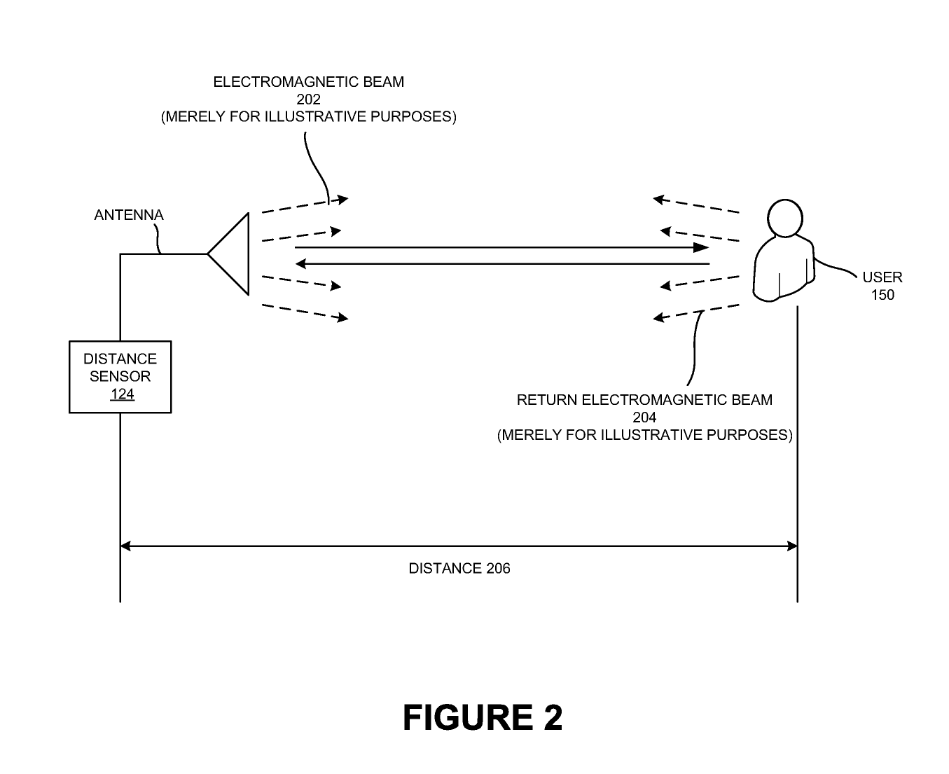

FIG. 2 shows an example distance sensor 124. In FIG. 2, distance sensor 124 may emit an electromagnetic beam 202 to user 150; the return electromagnetic beam 204 (e.g., beam reflected/scattered from user 150) may be analyzed (e.g., through processor 102 based on execution of post-processing engine 130) to determine changes thereto and, thereby, distance 206 between user 150 and display unit 112/data processing device 100. It is obvious that distance sensor 124 may be located in proximity to display unit 112 and that position thereof relative to display unit 112 may be fixed in order for the distance sensing to be accurate.

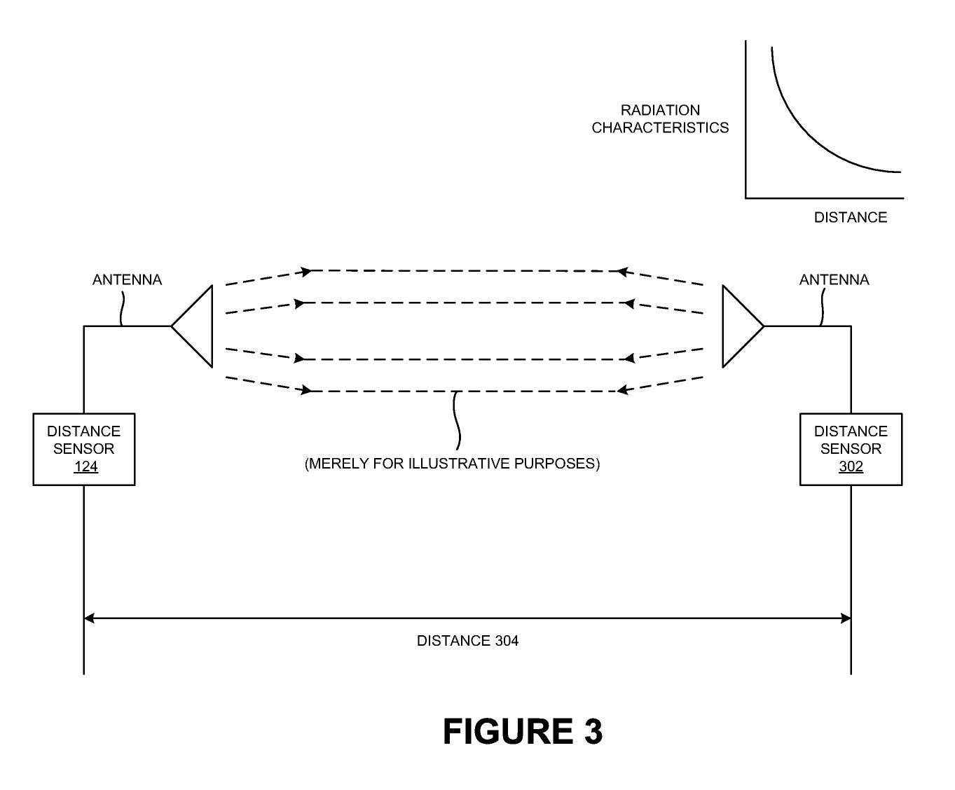

FIG. 3 shows an alternate embodiment of distance sensor 124. Here, another distance sensor 302 may be placed at the end of user 150. Distance sensor 124 at the end of display unit 112/data processing device 100 and distance sensor 302 may be antennas configured to transmit electromagnetic radiation therebetween. Depending on the distance (e.g., distance 304) between distance sensor 124 and distance sensor 302, the characteristic of the electromagnetic radiation may vary; sensing of distance 304 may, therefore, be possible. User 150 may, for example, have distance sensor 302 incorporated in a pair of goggles utilized for optimizing viewing of content on display unit 112 or other equipment amenable to accommodating distance sensor 302 therein.

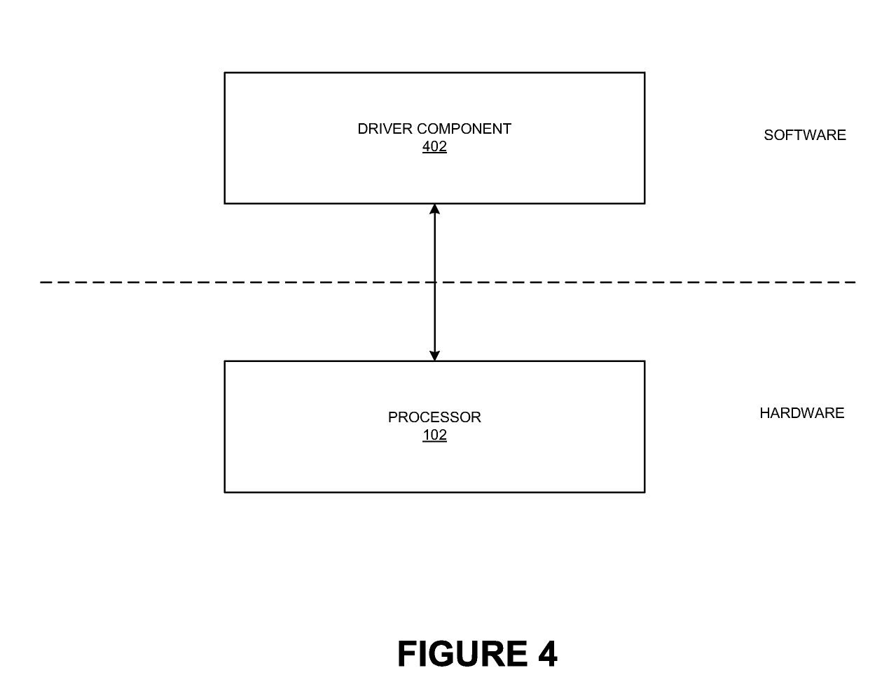

It is obvious that other forms of distance sensor 124 are within the scope of the exemplary embodiments discussed herein. FIG. 4 shows interaction between a driver component 402 (e.g., a software driver) and processor 102, according to one or more embodiments. Upon initiation of the distance sensing process through user 150 based on actions discussed above or through loading of operating system 126, driver component 402 may be configured to cause (e.g., through processor 102) distance sensor 124 to sense distance between user 150 and display unit 112/data processing device 100. In one or more embodiments, based on the sensed distance between user 150 and display unit 112/data processing device 100, processor 102 may be configured to modify display resolution 140 such that a readability of the rendered display data 116 is enhanced.

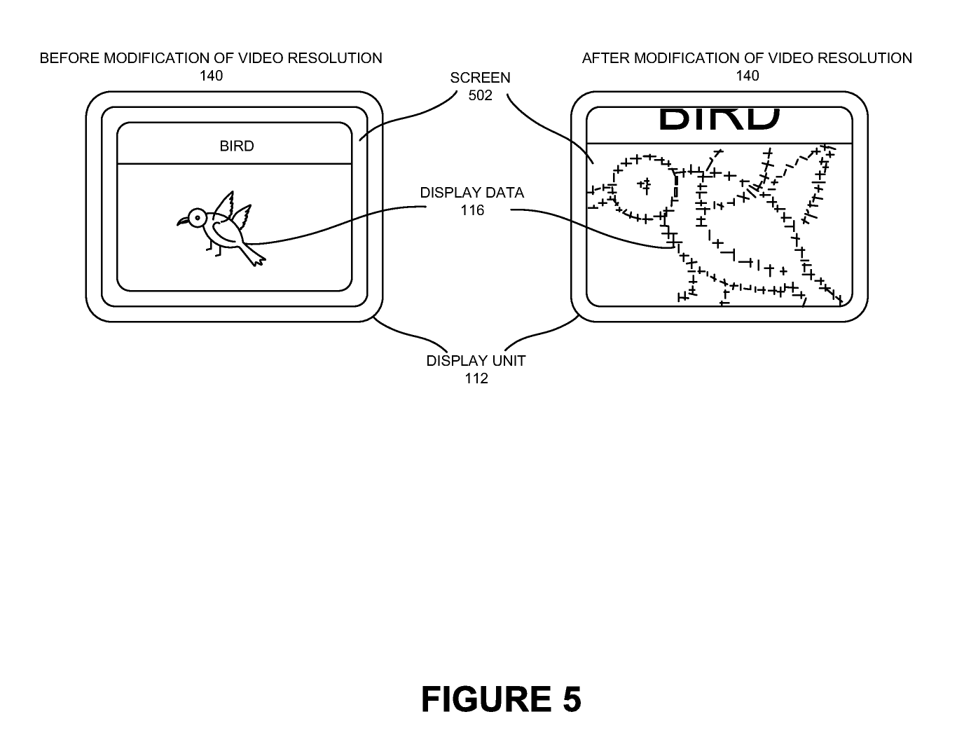

For example, user 150 may move away from display unit 112. In accordance therewith, display resolution 140 may be modified from a current value of 1600×900 to 800×600. FIG. 5 shows display data 116 on a screen 502 of display unit 112 upon modification of display resolution 140 based on the distance between user 150 and display unit 112/data processing device 100.

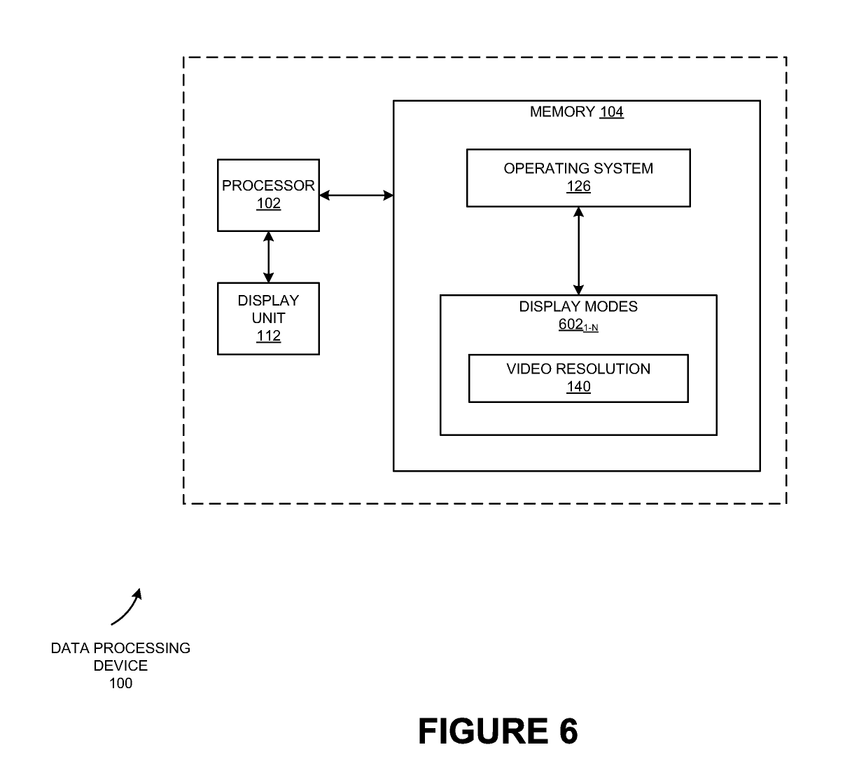

It is obvious that processor 102 may execute post-processing engine 130 to receive sensed data from distance sensor 124, to analyze the sensed data to determine the distance between user 150 and display unit 112/data processing device 100 and to modify display resolution 140 based on the determined distance. In one or more embodiments, display unit 112 may have a number of display modes having resolutions (e.g., PPI, pixels along a dimension of display unit 112) associated therewith. As shown in FIG. 6, a list of display modes 602_{1-N} may be associated with operating system 126; FIG. 6 shows display modes 602_{1-N} being stored in memory 104. In one or more embodiments, once processor 102 determines the distance between user 150 and display unit 112/data processing device 100, processor 102 may be configured to choose an appropriate display mode 602_{1-N}; as each display mode 602_{1-N} may have a display profile including display resolution 140 associated therewith, processor 102 may be configured to choose display mode 602_{1-N} such that readability of display data 116 with regard to user 150 is enhanced.

It may be possible that both PPI and the number of pixels along dimensions of display unit 112 may be modified as part of the modification of display resolution 140. In a lot of cases, operating system 126/display unit 112 may not support the aforementioned modification. Here, in one or more embodiments, processor 102 may scale display data 116 based on the execution of post-processing algorithm 130 to an appropriate level such that display data 116 may be displayed in the appropriate display mode 602_{1-N}.

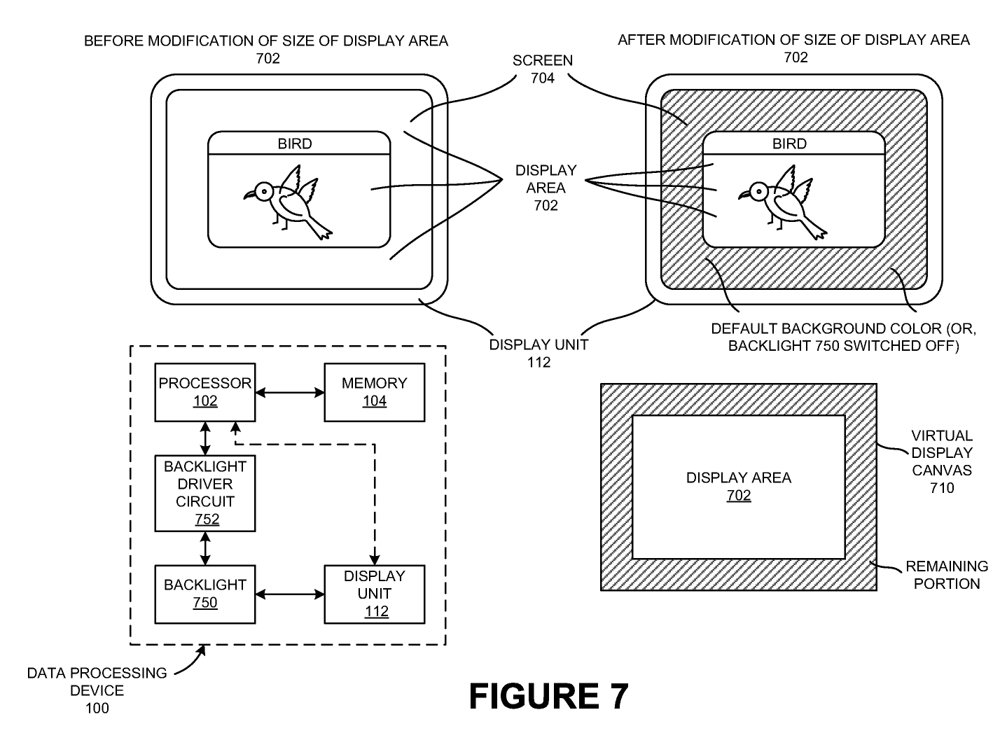

Concepts associated with the exemplary embodiments are not limited to modifying display resolution 140. FIG. 7 shows modification of a size of a display area 702 on a screen 704 of display unit 112, according to one or more embodiments. In one or more embodiments, display area 702 may be an area of screen 704 on which display data 116 is rendered. In one or more embodiments, operating system 126 may provide a virtual display canvas 710 on which display area 702 is located. In one or more embodiments, based on the determination of distance between user 150 and display unit 112/data processing device 100 through the execution of post-processing algorithm 130, processor 102 may be configured to scale display area 702 to an appropriate size within which display data 116 is readable.

In one example embodiment, when user 150 is determined to be reasonably close to display unit 112/data processing device 100, processor 102 may be configured to scale down display area 702 in size from a current size thereof. The remaining portion of virtual display canvas 710 may be rendered in a default background color (e.g., black). Alternately, a backlight 750 of display unit 112 may be switched off (or, in another example, reduced in intensity) for a portion corresponding to the remaining portion; backlight 750 may be configured to illuminate virtual display canvas 710.

FIG. 7 shows processor 102 being interfaced with backlight 750 through a backlight driver circuit 752. Upon determination of the distance discussed above, processor 102 may be configured to transmit a control signal to backlight driver circuit 752 to switch backlight 750 off for a portion corresponding to the remaining portion of virtual display canvas 710 discussed above. For example, processor 102 may be configured to detect boundaries of display area 702, based on which the appropriate portion of virtual display canvas 710 for which backlight 750 is to be switched off is detected. It is obvious that the aforementioned action/action(s) may provide for reduced power consumption in data processing device 100.

It should be noted that there may be an optimum display resolution 140 (or, size of display area 702) for a range of distances between user 150 and display unit 112/data processing device 100. Therefore, in one or more embodiments, a current display resolution 140 or size of display area 702 may be deemed to be optimal through processor 102, in which case, no modification to display resolution 140 or display area 702 is required. Further, it is obvious that display area 702 may be increased in size (and backlight 750 switched on completely for all portions of virtual display canvas 710) when user 150 goes farther away from display unit 112/data processing device 100. Still further, it should be noted that both display resolution 140 and the size of display area 702 may be modified in certain cases.

In one or more embodiments, appropriate scaling of display data 116 may be performed through processor 102 to fit said display data 116 within modified display area 702. In one or more alternate embodiments, no scaling of display data 116 may be done and display data 116 may be fit into the modified display area 702 as is. All reasonable variations are within the scope of the exemplary embodiments discussed herein.

The driver component (e.g., driver component 402) discussed above or equivalent software thereof and/or post-processing engine 130 discussed above may be stored in memory 104 to be installed on data processing device 100 after a download through, for example, the Internet. Alternately, an external memory may be utilized therefor. Also, instructions associated with the driver component and/or post-processing engine 130 may be embodied on a non-transitory medium readable through data processing device 100 such as a Compact Disc (CD), a Digital Video Disc (DVD), a Blu-ray Disc® and a hard drive. The aforementioned instructions may be executable through data processing device 100.

The set of instructions associated with the driver component or equivalent software thereof is not limited to specific embodiments discussed above, and may, for example, be implemented in operating system 126, an application program (e.g., application 170), a foreground or a background process, a network stack or any combination thereof. The driver component may not solely be associated with processor 102, as shown in FIG. 4. The driver component may be associated with processor 102, display unit 112 and/or distance sensor 124. Other variations are within the scope of the exemplary embodiments discussed herein.

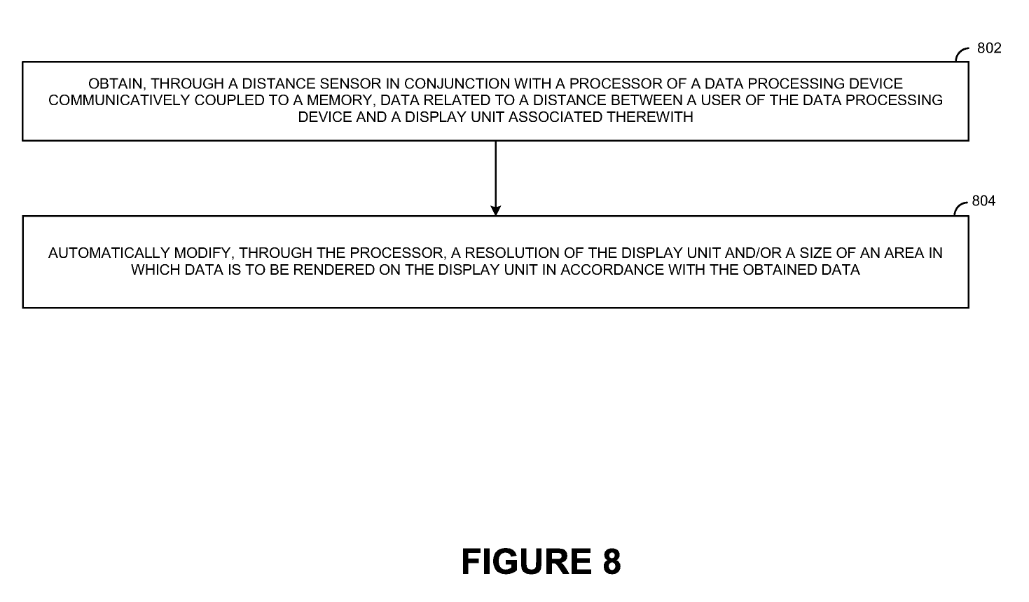

FIG. 8 shows a process flow diagram detailing the operations involved in user based modification of display resolution 140 and/or a size of display area 702, according to one or more embodiments. In one or more embodiments, operation 802 may involve obtaining, through distance sensor 124 in conjunction with processor 102, data related to a distance between user 150 and display unit 112 associated therewith. In one or more embodiments, operation 804 may then involve automatically modifying, through processor 102, display resolution 140 and/or the size of display area 702 in accordance with the obtained data.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structures and methods may be embodied using transistors, logic gates, and electrical circuits (e.g., application specific integrated (ASIC) circuitry and/or Digital Signal Processor (DSP) circuitry).

In addition, it will be appreciated that the various operations, processes and methods disclosed herein may be embodied in a non-transitory machine-readable medium and/or a machine-accessible medium compatible with a data processing system (e.g., data processing device 100). Accordingly, the specification and drawings are to be regarded in an illustrative rather than a restrictive sense.

What is claimed is:

1. A method comprising:
obtaining, through a distance sensor in conjunction with a processor of a data processing device communicatively coupled to a memory, data related to a distance between a user of the data processing device and a display unit associated therewith; and
automatically modifying, through the processor, at least one of: a resolution of the display unit and a size of an area in which data is to be rendered on the display unit in accordance with the obtained data.

2. The method of claim 1, comprising modifying a number of pixels of the data to be rendered on the display unit along at least one of: a unit distance of a dimension of the display unit and an entire distance thereof as the resolution of the display unit.

3. The method of claim 1, further comprising triggering at least one of: the obtainment of the data related to the distance and the automatic modification of the at least one of: the resolution and the size of the area through a driver component associated with at least one of: the processor, the display unit and the distance sensor.

4. The method of claim 3, further comprising initiating the triggering through at least one of: a physical button associated with at least one of: the data processing device and the display unit, a user interface provided through an application executing on the data processing device and loading of an operating system executing on the data processing device.

5. The method of claim 1, wherein when the size of the area is scaled down within a virtual display canvas provided through an operating system executing on the data processing device in accordance with the obtained data, the method further comprises one of:
rendering, through the processor, a remaining portion of the virtual display canvas not comprising the area in a default background color; and
reducing, through the processor, an intensity of a backlight of the display unit for a portion corresponding to the remaining portion during rendering of the data within the area.

6. The method of claim 5, further comprising detecting, through the processor, boundaries of the area to determine the portion corresponding to the remaining portion for which the intensity of the backlight is to be reduced.

7. The method of claim 1, comprising at least one of:
maintaining a current at least one of: the resolution of the display unit and the size of the area for a range of distances between the user and the display unit obtained; and
scaling, through the processor, the data to be rendered on the display unit to correspond to the modified at least one of: the resolution and the size of the area.

8. A non-transitory medium, readable through a data processing device and comprising instructions embodied therein that are executable through the data processing device, comprising:
instructions to obtain, through a distance sensor in conjunction with a processor of the data processing device communicatively coupled to a memory, data related to a distance between a user of the data processing device and a display unit associated therewith; and
instructions to automatically modify, through the processor, at least one of: a resolution of the display unit and a size of an area in which data is to be rendered on the display unit in accordance with the obtained data.

9. The non-transitory medium of claim 8, comprising instructions to modify a number of pixels of the data to be rendered on the display unit along at least one of: a unit distance of a dimension of the display unit and an entire distance thereof as the resolution of the display unit.

10. The non-transitory medium of claim 8, further comprising instructions to trigger at least one of: the obtainment of the data related to the distance and the automatic modification of the at least one of: the resolution and the size of the area through a driver component associated with at least one of: the processor, the display unit and the distance sensor.

11. The non-transitory medium of claim 10, further comprising instructions to initiate the triggering through at least one of: a physical button associated with at least one of: the data processing device and the display unit, a user interface provided through an application executing on the data processing device and loading of an operating system executing on the data processing device.

12. The non-transitory medium of claim 8, wherein when the size of the area is scaled down within a virtual display canvas provided through an operating system executing on the data processing device in accordance with the obtained data, the non-transitory medium further comprises instructions to one of:
render, through the processor, a remaining portion of the virtual display canvas not comprising the area in a default background color; and
instructions to reduce, through the processor, an intensity of a backlight of the display unit for a portion corresponding to the remaining portion during rendering of the data within the area.

13. The non-transitory medium of claim 12, further comprising instructions to detect, through the processor, boundaries of the area to determine the portion corresponding to the remaining portion for which the intensity of the backlight is to be reduced.

14. A data processing device comprising:
a memory;
a processor communicatively coupled to the memory; and
a distance sensor interfaced with the processor, the distance sensor being configured to obtain data related to a distance between a user of the data processing device and a display unit associated therewith in conjunction with the processor,
wherein, in accordance with the obtained data related to the distance, the processor is configured to execute instructions to automatically modify at least one of: a resolution of the display unit and a size of an area in which data is to be rendered on the display unit.

15. The data processing device of claim 14, wherein the processor is configured to execute instructions to modify a number of pixels of the data to be rendered on the display unit along at least one of: a unit distance of a dimension of the display unit and an entire distance thereof as the resolution of the display unit.

16. The data processing device of claim 14, further comprising a driver component associated with at least one of: the processor, the display unit and the distance sensor to trigger at least one of: the obtainment of the data related to the distance and the automatic modification of the at least one of: the resolution and the size of the area.

17. The data processing device of claim 16, wherein the triggering is initiated through at least one of: a physical button associated with at least one of: the data processing device and the display unit, a user interface provided through an application executing on the data processing device and loading of an operating system executing on the data processing device.

18. The data processing device of claim 14, wherein when the size of the area is scaled down within a virtual display canvas provided through an operating system executing on the data processing device in accordance with the obtained data, the processor is further configured to execute instructions to one of:
render a remaining portion of the virtual display canvas not comprising the area in a default background color, and
reduce an intensity of a backlight of the display unit for a portion corresponding to the remaining portion during rendering of the data within the area.

19. The data processing device of claim 18, wherein the processor is further configured to execute instructions to detect boundaries of the area to determine the portion corresponding to the remaining portion for which the intensity of the backlight is to be reduced.

20. The data processing device of claim 14, wherein the processor is further configured to execute instructions to at least one of:
maintain a current at least one of: the resolution of the display unit and the size of the area for a range of distances between the user and the display unit obtained, and
scale the data to be rendered on the display unit to correspond to the modified at least one of: the resolution and the size of the area.
